(19) United States
(12) Patent Application Publication
(10) Pub. No.: US 2006/0146689 A1
(43) Pub. Date: Jul. 6, 2006

(54) Method for data transmission by means of a field bus of an automation device

(75) Inventor: Joerg Roth, Lorrach (DE)

Correspondence Address: BACON & THOMAS, PLLC, 625 SLATERS LANE, FOURTH FLOOR, ALEXANDRIA, VA, 22314, US

(73) Assignee: Endress + Hauser Flowtec AG, Reinch (CH)

(21) Appl. No.: 10/536,324

(22) PCT Filed: Nov. 26, 2003
(86) PCT No.: PCT/EP03/13273

§ 371 Date: Nov. 14, 2005

(30) Foreign Application Priority Data
Nov. 28, 2002 (DE) 102 55 743.8

(51) Int. Cl. H04J 11/00

(52) U.S. Cl. 370/203

(57) ABSTRACT

A method for transferring data via a field bus FB of an automation system, to which field bus multiple field devices D1, D2, D3, . . . ,Dn, V1, V2, V3, . . . ,Vn are connected. The field bus FB has multiple data channels, to which the field devices have simultaneous access.

The invention concerns a method for transferring data via a field bus of an automation system, in accordance with the preamble of claim 1.

In the field of automation technology, field devices are frequently used which register or influence process variables in an automation system. Examples of such field devices are flow meters, temperature meters, and pressure meters. These register the corresponding process variables—e.g. flow rate, temperature, and pressure. Such field devices are also referred to as sensors. Valves are an additional field-device category, and, as actuators, influence the flow rate in a section of pipeline.

Generally, the field devices are connected with a control unit (e.g. a programmable logic controller, or PLC for short) via a field bus. The field bus is also usually connected with superordinated firm networks, which enable the process flow to be monitored and observed.

Conventional field busses (Profibus®, Foundation Fieldbus®, etc.) operate by time multiplexing, that is, at a given point in time, only one bus participant can access the bus, and thus transmit data. This is problematic in the case of very rapid process flows, in which data from different sensors must be registered quasi-simultaneously, and the associated valves must also be actuated simultaneously. Such rapid process flows are found, for example, in bottling plants, especially in the case of round bottling machines. In bottling plants, it is a matter of filling a product into a container in an exactly metered, predetermined amount in a very short time. The filling times for a container can lie between 0.1 and 1 second.

In the case of round bottling machines, multiple filling stations are arranged circularly on a carousel, and must be actuated in short separations in time.

A further disadvantage in the case of round bottling machines is that an electrical connection between a locationally fixed mechanism and a mechanism on the carousel can only be achieved via slip contacts. The power supply of the electrical mechanisms found on the carousel is also accomplished via such slip contacts.

In the case of conventional field bus systems (Profibus® Foundation Fieldbus®, etc.), a rapid and secure data transfer using slip contacts during operation is not possible. For this reason, a field bus is always confined to the area of the carousel, i.e. the controller which controls the filling must also be arranged on the carousel. This means, however, at the same time, that the controller operates completely self-sufficiently, and cannot be influenced from the outside.

In the case of errors that may occur, for example the overfilling of a container always at one filling station, or for adjustment, e.g. a density correction in the case of Coriolis mass flow meters, the bottling system must be stopped and the appropriate changes to the controller or the field devices carried out. The availability of the system is thereby diminished, which results in not insignificant costs.

An object of the present invention is to provide a method for transferring data using a field bus of an automation system, which method does not have the above-mentioned disadvantages, and which especially enables a rapid and secure data transfer.

This object is achieved through the method defined in claim 1. An essential idea of the invention is to make multiple data channels available on the field bus for the field devices, such that multiple field devices have simultaneous access to the field bus.

Advantageous further developments are given in the dependent claims. Advantageously, the access to the data channels is accomplished by the frequency-multiplexing method. An example of such a frequency-multiplexing method is the OFDM (Orthogonal Frequency Domain Multiplex) method, which is very robust against disturbances.

Advantageously, field devices are connected together in pairs, with each pair having its own assigned data channel on the data bus. A permanent correlation between sender and receiver is thus provided.

An example of a paired correlation is a flow meter and a valve in a bottling system. The connection between a locationally fixed controller and the moving field devices is accomplished via a slip ring.

The invention will now be described in greater detail on the basis of an example of an embodiment illustrated in the drawing, the figures of which show as follows:

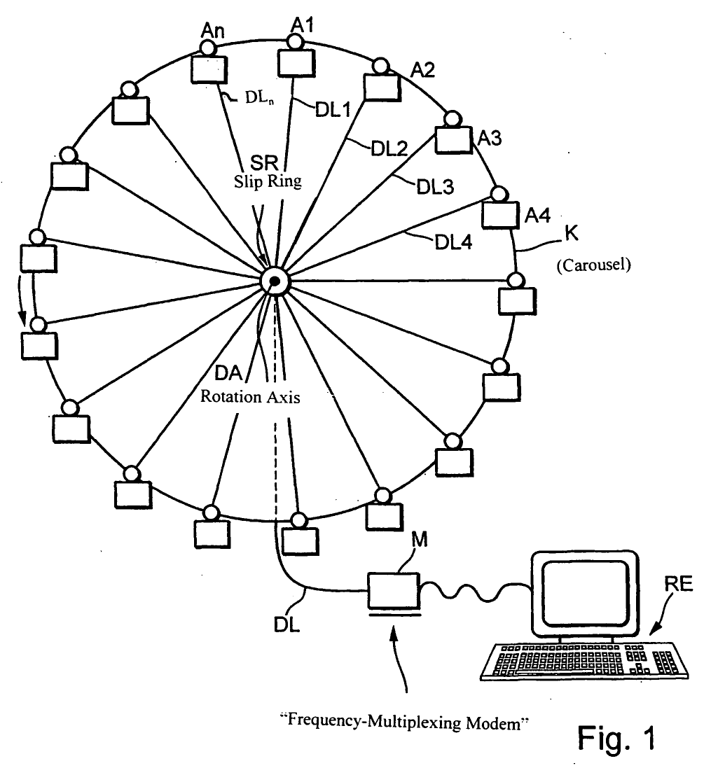

FIG. 1 a schematic illustration of a round bottling machine;

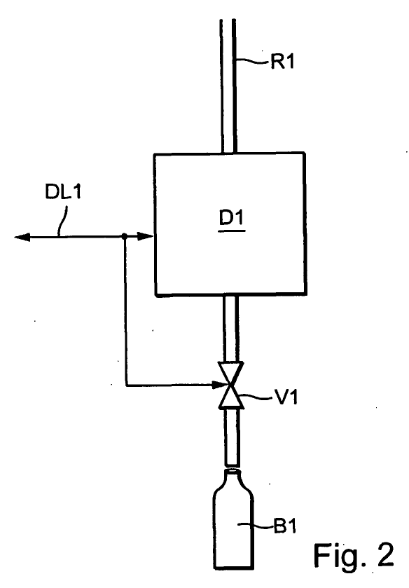

FIG. 2 a schematic illustration of a filling station of a round bottling machine according to FIG. 1;

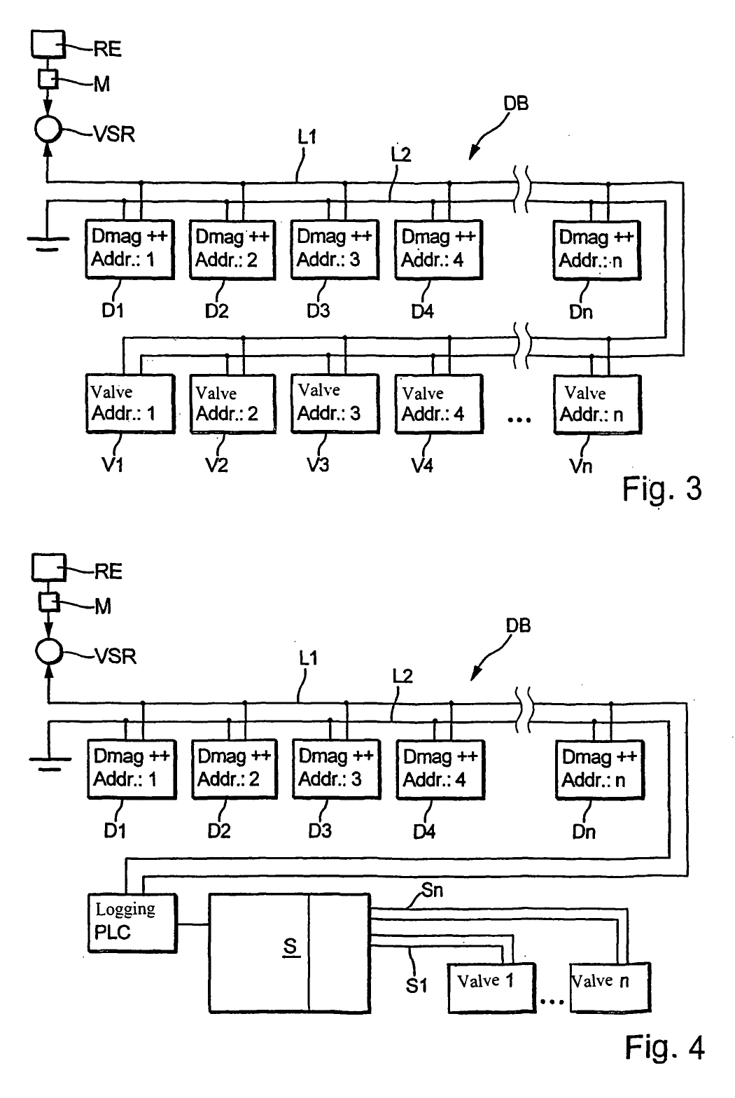

FIG. 3 communication connection on a round bottling machine according to a first variant of the invention; and

FIG. 4 communication connection on a round bottling machine according to a second variant of the invention.

In FIG. 1, the illustrated bottling system includes a round bottling machine with multiple filling stations A1, A2, A3 . . . An, arranged circularly on a carousel K. The axis of rotation of carousel K is denoted by DA. At the axis of rotation DA, a slip ring SR is arranged, from which data lines DL1, . . . ,DLn lead to their associated filling stations A1, . . . ,An. The slip ring SR is connected via a data line DL with a modem M, to which a computing unit RE is connected.

Each filling station is identically constructed. FIG. 2 shows, by way of example, the station A1, with a flow meter D1, which measures the quantity, or amount, of the product to be filled, measured in terms of volume or mass, as the case may be. The fill quantity is controlled via a valve V1, which is also located in a supply line R1. Product supply to the filling station A1 is accomplished via the supply line R1. A container B1 (sketched as a bottle) is arranged below the outlet of supply line R1.

After the filling, the full container B1 is conveyed away from the filling station A1, and a new, empty container is conveyed to it. The residence time of a container at a filling station can lie in the range of 0.1 to 1 second. In the case of large round-bottling-machines, up to 10,000 bottles per hour can be filled.

Actuation of valve V1 is accomplished either from a control unit S, or from the associated flow meter D1, via the data line DL1. For this, the information of the flow meter D1 is evaluated in the control unit S, or in the flow meter D1 itself. Valve V1 is actuated such that the quantity of the filled product exactly equals the desired quantity. Here, especially the amount of after-run of the valve must be taken into account. The control signal for the valve must be produced before the flow meter D1 has measured the desired quantity, since the valve V1 has a finite reaction time, and thus always has a certain amount of after-run.

FIG. 3 illustrates schematically a communication connection for a round bottling machine. A data bus DB has a pair of lines L1, L2, which are connected with all of the field devices on the carousel K. Communications and power supply of the field devices are accomplished via the pair of lines L1, L2. Line L1 is connected with the modem M and computing unit RE via a supply slip ring VSR. In the case of this variant as illustrated, the field devices control the filling process without an additional control unit S. Appropriate algorithms can be implemented in the field devices. Through the connection with the computing unit RE, the field devices can also be accessed while in operation, in order to carry out particular adjustments.

A further variant of a communication connection is illustrated in FIG. 4. Here, the pair of lines L1, L2 is connected only with the flow meters D, a control unit S, and, via the supply slip ring VSR, with the modem M and the computing unit RE. The control unit S controls valves V1, . . . ,Vn via control lines S1, . . . ,Sn, respectively. Here, the control unit S is arranged on the carousel K.

The variants of FIGS. 3 and 4 reference the flow meters D with “Dmag ++”, which is an abbreviation for the Dosimag electromagnetic flow measuring device of the assignee, with the “++” indicating provision for possible future model numbers. FIGS. 3 and 4 also indicate that each field device attached to the bus has an address, “Addr.: 1”, etc.

The method of the invention will now be described in greater detail as follows.

Because the filling time for each container is relatively short, and each filling station must exchange data in parallel between its flow meter, the computing unit RE, and its valve, the field bus has multiple data channels, to which the field devices have simultaneous access.

An opportunity for simultaneous access to a field bus is provided by the frequency-multiplexing method. A very secure and robust method for data transfer is the OFDM-method.

In the case of filling systems, it has proven especially favorable when each flow meter D and its associated valve V are connected via their own, one, data channel.

Via the computing unit RE, changes to the settings of the field devices or the control unit S can be carried out, without interrupting the operation of the round bottling machine.

The OFDM (Orthogonal Frequency Domain Multiplex)-method forms the physical layer in the OSI (Open Systems Interconnect) Reference Model. For this, the protocols superimposed on this layer, such as Profibus®, Foundation Fieldbus®, etc., are independent.

The invention thereby distinguishes itself in that multiple field devices can communicate simultaneously via one data bus, which, in the case of time-critical applications, is of great importance. With the OFDM-method, a robust method for data transfer is available, which is also suitable for data busses that have slip contacts as connection elements.

Translation of German Words in the Drawings

FIG. 1:

Change “DLu” to --DLn--;
change “Schleifring” to --slip ring--;
change “(Karussel)” to --(carousel)--;
change “Drehachse” to --rotation axis--; and
change “Frequenzmultiplex Modem” to --frequency-multiplexing modem--.
   FIG. 3:
Change “Vent”, each occurrence, to --Valve--.
   FIG. 4:
Change “Abgriff PLC” to --Logging PLC--; and
change “Vent”, each occurrence, to --Valve--.

1-7. (canceled)

8. A method for transferring data via an automation system field bus, to which multiple field devices D1, D2, D3, . . . ,Dn, V1, V2, V3, . . . ,Vn are connected, comprising the steps of:
providing the field bus FB with multiple data channels; and
providing simultaneous access for the field devices D1, D2, D3, . . . ,Dn, V1, V2, V3, . . . ,Vn to the multiple data channels.

9. The method as claimed in claim 8, wherein:
said simultaneous access to the data channels is accomplished by frequency-multiplexing.

10. The method as claimed in claim 9, wherein:
an OFDM-method is used as for frequency-multiplexing.

11. The method as claimed in claim 8, further comprising the step of:
connecting the multiple field devices D1, D2, D3, . . . ,Dn, V1, V2, V3, . . . ,Vn in pairs, each pair having its own assigned data channel.

12. The method as claimed in claim 11, wherein:
in each case, one field device D1, D2, D3, . . . ,Dn, and one valve V1, V2, V3, . . . ,Vn form a pair.

13. The method as claimed in claim 8, wherein:
the automation system is a bottling plant.

14. A field device for process automation technology, comprising in combination:
a field bus with multiple data channels to which the field device has simultaneous access with other like field devices.
